(19) United States
(12) Patent Application Publication
(10) Pub. No.: US 2024/0025503 A1
(43) Pub. Date: Jan. 25, 2024

(54) Bike Repair Stand

(71) Applicant: Louis Chuang, Taichung (TW)

(72) Inventor: Louis Chuang, Taichung (TW)

(21) Appl. No.: 18/156,023

(22) Filed: Jan. 18, 2023

(30) Foreign Application Priority Data
Jul. 25, 2022 (TW) 111127808

(51) Int. Cl. B62H 3/12; B25H 1/00

(52) U.S. Cl. CPC B62H 3/12; B25H 1/0042

(57) ABSTRACT

A bike repair stand has a support rod assembly including a plurality of supporting legs selectively fold up and spread apart and an extension rod assembly including first and second connection structures and first, second, and third extension rods. The first connection structure is mounted to the upright pole. The first extension rod is rotatably connected to the first connection structure. The second connection structure is mounted to the first extension rod. The second extension rod is movably connected to the second connection structure. The third extension rod is mounted to the second connection structure. The extension rod assembly further includes first, second, and third carriers. The first carrier is mounted to the second connection structure. The second carrier is mounted to the second extension rod. The third carrier is mounted to a second end of the third extension rod.

### BACKGROUND OF THE INVENTION

The present invention relates to a bike repair stand and, particularly, to a bike repair stand which provides a multi-points support and is angle adjustable.

TW Patent No. M525826discloses a bike repair stand including a foldable frame structure and a support column which includes a positioning ring and a lifting column. The lift column includes a joint which includes an angle adjustable clamp. The frame structure includes a sliding seat inserted and fit on the support column and also two legs pivotally connected to the sliding seat. The bottom of the support column has a sleeve, the sleeve and the first leg include a first linkage coupled therebetween, and the sleeve and the second leg include a second linkage coupled therebetween. When the bike repair rack is extended for use, the sliding seat is moved toward the sleeve and away from the positioning ring, the first and second linkages push the first and the second legs to spread out and to be located under the sides of the first and the second legs, and the movable clamp is used to clamp a bike frame. The clamp, however, provides a single-point fixing effect and is too fragile to stand the weight of the bike frame and therefore the bike frame can detach from the bike repair stand easily. Also, if a user's exerts a large force on the bike frame while repairing the bike, the clamp and the bike repair stand are subject to a large toque and can damage easily.

The present invention is, therefore, intended to obviate or at least alleviate the problems encountered in the prior art.

### SUMMARY OF THE INVENTION

A bike repair stand has a support rod assembly which includes an upright pole, a sliding seat, a plurality of supporting legs, and a plurality of linkages. The sliding seat is movably connected to and movable along the upright pole in a transition between collapsed and extended positions of the bike repair stand. Each of the plurality of supporting legs has a first end pivotally connected to the sliding seat and a second end. Each of the plurality of linkages has a first end pivotally connected to the upright pole and a second end pivotally connected to one of the plurality of supporting legs. The sliding seat is in a first position the plurality of supporting legs fold up when the bike repair stand is in the collapsed position. The sliding seat is in a second position the plurality of supporting legs spread apart when the bike repair stand is in the extended position. The bike repair stand also has an extension rod assembly which includes a first connection structure, a first extension rod, a second connection structure, a second extension rod, and a third extension rod. The first connection structure is mounted to the upright pole. The first extension rod is arranged in a horizontal direction and has a first end rotatably connected to the first connection structure and a second end. The second connection structure is mounted to the second end of the first extension rod. The second extension rod is movably connected to the second connection structure and arranged orthogonal to the first extension rod. The third extension rod has a first end mounted to the second connection structure and a second end. The extension rod assembly further includes first, second, and third carriers on which a bike is contacted. The first carrier is mounted to the second connection structure. The second carrier is mounted to the second extension rod. The third carrier is mounted to the second end of the third extension rod.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components assembly forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for designing of other structures, methods and systems for carrying out the several purposes of the present invention. It is important, therefore, that the claims be regarded as including such equivalent constructions insofar as they do not depart from the spirit and scope of the present invention.

Further, the purpose of the abstract is to enable the public generally, and especially scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF DRAWINGS

FIG. 1 is a perspective view illustrating a bike repair stand in accordance with the present invention in an extended positon.

FIG. 2 shows a perspective view of an extension rod assembly of the bike repair stand of FIG. 1.

FIG. 3 is an exploded perspective view of the extension rod assembly.

FIG. 4 is a cross-sectional view of a first connection structure of the bike repair stand of FIG. 1.

FIG. 5 is a cross-sectional view of a second connection structure of the bike repair stand of FIG. 1.

FIG. 6 is a perspective view illustrating the bike repair stand of FIG. 1 supporting a bike in one angular positon.

FIG. 7 is a perspective view illustrating the bike repair stand of FIG. 1 supporting the bike in another angular position.

FIG. 8 is a perspective view illustrating the bike repair stand in a collapsed position.

### DETAILED DESCRIPTION OF THE INVENTION

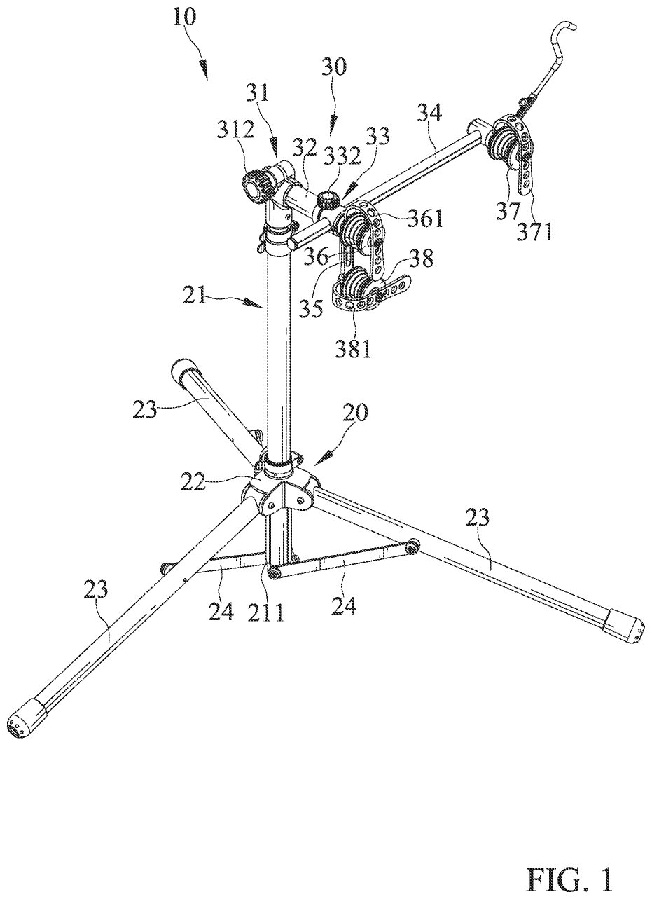

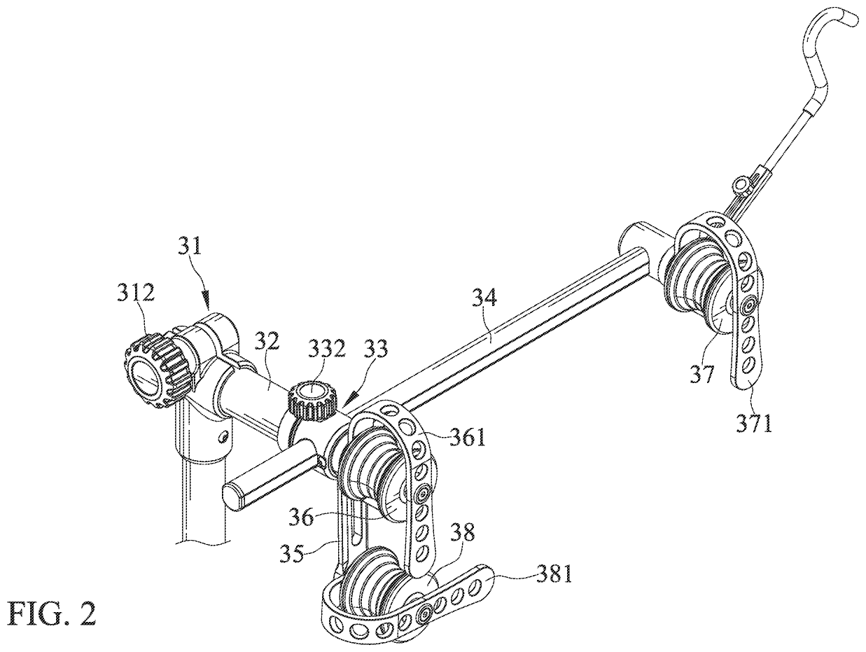

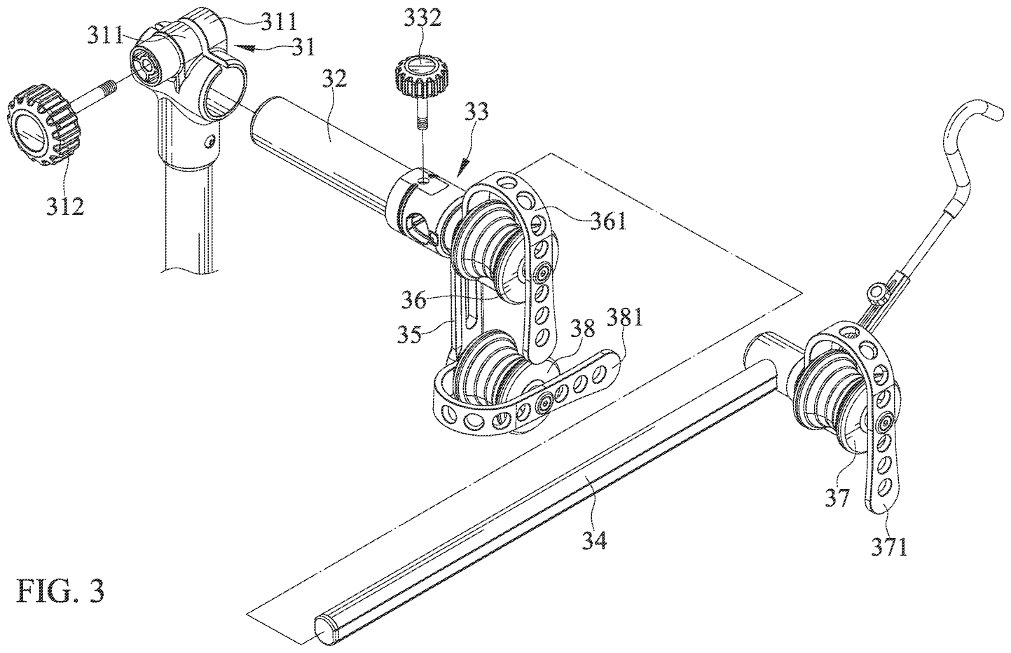

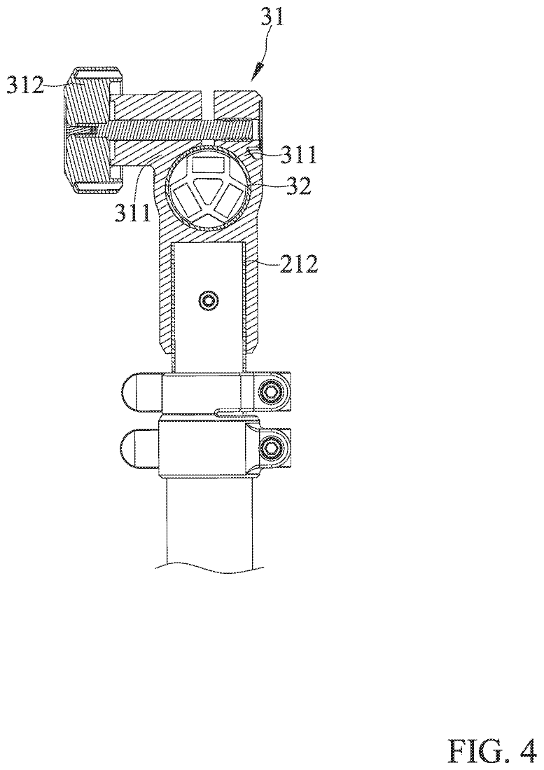

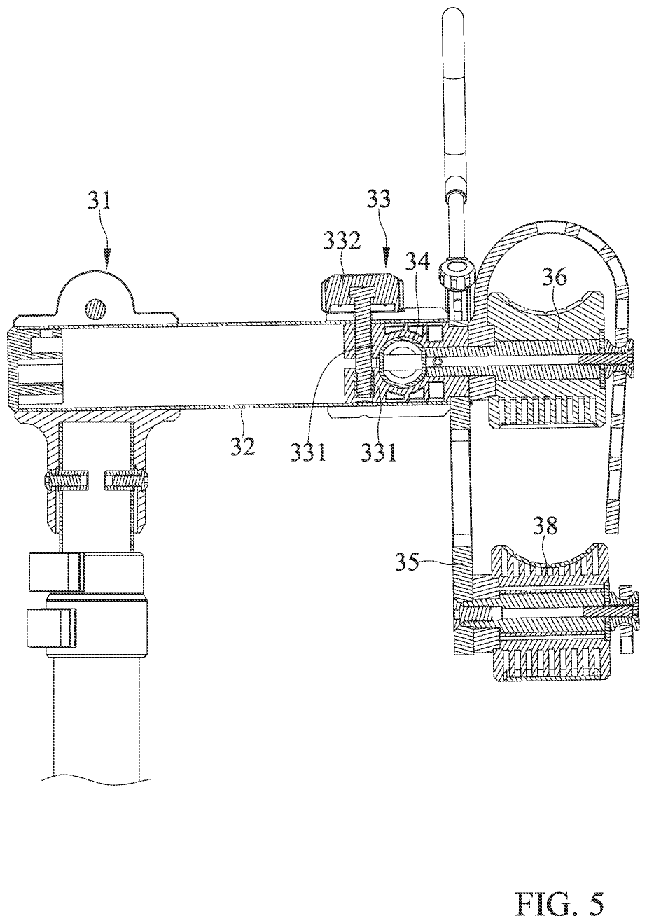

FIGS. 1-7 show a bike repair stand 10 according to the present invention. The bike repair stand 10 includes a support rod assembly 20 and an extension rod assembly 30.

The support rod assembly 20 includes an upright pole 21, a sliding seat 22, a plurality of supporting legs 23, and a plurality of linkages 24. The upright pole 21 has a bottom end 211 and a top end 212 opposite the bottom end 211. The sliding seat 22 is movably connected to and movable along the upright pole 21 in a transition between collapsed and extended positions of the bike repair stand 10. Each of the plurality of supporting legs 23 has a first end pivotally connected to the sliding seat 22 and a second end. Each of the plurality of linkages 24 has a first end pivotally connected to the upright pole 21 and a second end pivotally connected to one of the plurality of supporting legs 23. Furthermore, each of the of the plurality of linkages 24 includes the first end thereof pivotally arranged at the bottom end 211 of the upright pole 21 and the second end thereof pivotally arranged between the first and the second ends of the connected supporting leg 23. The sliding seat 22 is in a first position the plurality of supporting legs 23 fold up when the bike repair stand 10 is in the collapsed position. The sliding seat 22 is in a second position the plurality of supporting legs 23 spread apart when the bike repair stand 10 is in the extended position.

The extension rod assembly 30 includes a first connection structure 31, a first extension rod 32, a second connection structure 33, a second extension rod 34, and a third extension rod 35. The first connection structure 31 is mounted to the upright pole 21. Furthermore, the first connection structure 31 is arranged at the top end 212. The first extension rod 32 is arranged in a horizontal direction and has a first end rotatably connected to the first connection structure 31 and a second end. The first extension rod 32 is movable relative to the first connection structure 31 on a horizontal plane. The first connection structure 31 includes two first clamping arms 311 for clamping first extension rod 32 and a first fastener 312 connected to the first clamping arms 311. The first extension rod 32 is arranged between the first clamping arms 311. The first fastener 312 is inserted into the two first clamping arms 311 and in thread engagement with one of the two first clamping arms 311. The first fastener 312 is movable between a tightening position in which the first extension rod 32 is tightly clamped by the first clamping arms 311 and prevented from movement and rotation and an untightening position in which the first extension rod 32 is released from the first clamping arms 311 and movable. The second connection structure 33 is mounted to the second end of the first extension rod 32. The second extension rod 34 is movably connected to the second connection structure 33 and arranged orthogonal to the first extension rod 32. The second connection structure 33 includes two second clamping arms 331 for clamping the second extension rod 34 and a second fastener 332 engaged with the two second clamping arms 331. The second extension rod 34 is arranged between the two second clamping arms 331. The second fastener 332 is inserted into the two second clamping arms 331 and in thread engagement with one of the two second clamping arms 331. The second fastener 332 is movable between a tightening position in which the second extension rod 34 is tightly clamped by the second clamping arms 331 and prevented from movement and an untightening position in which the second extension rod 34 is released from the second clamping arms 331 and movable. The third extension rod 35 has a first end mounted to the second connection structure 33 and a second end. The third extension rod 35 has a first end rotatably connected to the second connection structure 33 and is positionable at various angular positions fixedly with respect to the second connection structure 33.

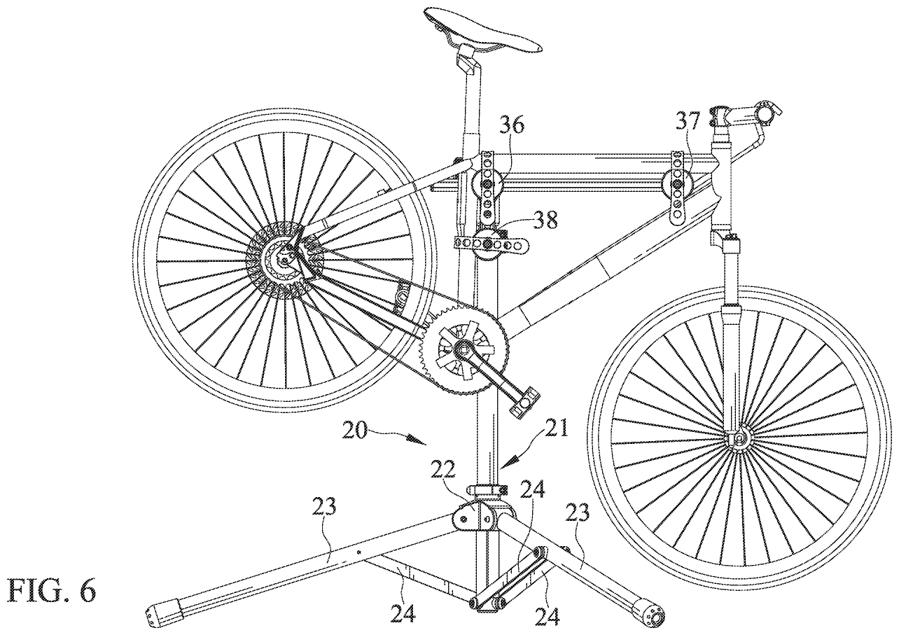

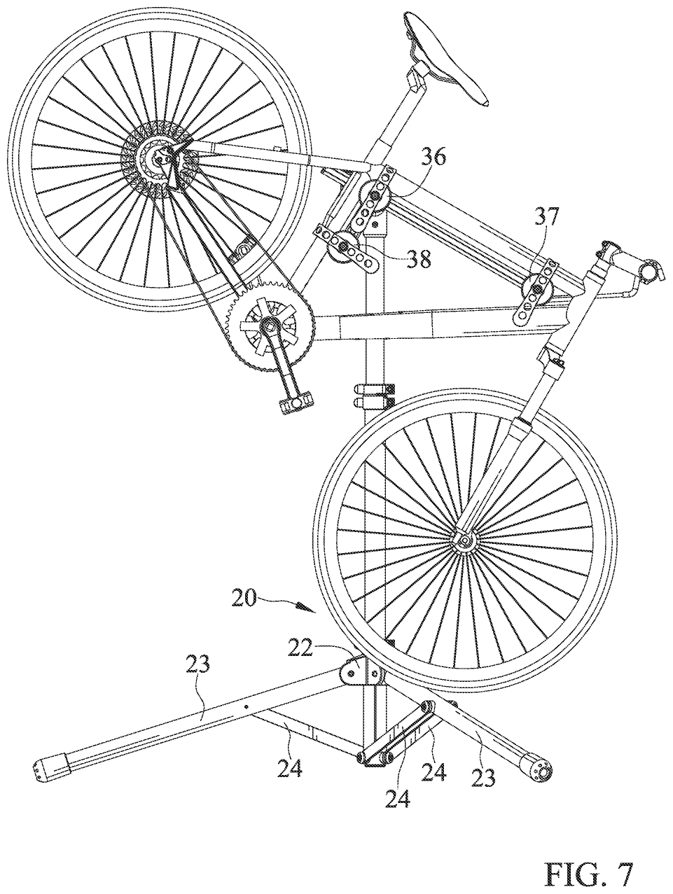

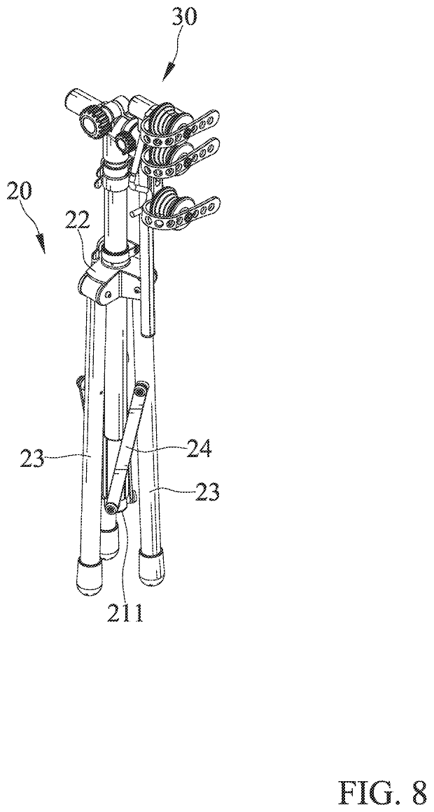

The extension rod assembly 30 further includes first, second, and third carriers 36, 37, and 38 on which a bike is contacted. The first carrier 36 is mounted to the second connection structure 33. The first carrier 36 has a first end adjacent to the second connection structure 33 and a second end opposite the first end distant from the second connection structure 33. The second carrier 37 is mounted to the second extension rod 34. The second carrier 37 has a first end adjacent to the second extension rod 34 and a second end opposite the first end distant from the second extension rod 34. The third carrier 38 is mounted to the second end of the third extension rod 35. The third carrier 38 has a first end adjacent to the third extension rod 35 and a second end opposite the first end distant from the third extension rod 35. As shown in FIGS. 6 and 7, the first and the second carrier 36 and 37 cooperate to hold a top tube of the bike, while the third carrier 38 holds the seat tube. Each of the first, the second, and the third carriers 36, 37, and 38 has a smaller cross section that that of each of the first and the second ends. As shown in FIG. 8, the first, the second, and the third carriers 36, 37, and 38 are arranged along a vertical direction of the bike repair stand 10 at different heights and disposed adjacent to the upright pole 21 when the bike repair stand 10 is in the collapsed position.

The first, the second, and the third carriers 36, 37, and 38 respectively include first, second, and third restrainers 361, 371, and 381 attached thereto and configured to fasten the bike to the corresponding carriers 36, 37, and 38. The first restrainer 361 is a belt and has a first end and a second end corresponding and attached to the first end and the second end of the first carrier 36. The second restrainer 371 is a belt and has a first end and a second end corresponding and attached to the first and the first end and the second end of the second carrier 37. The third restrainer 381 is a belt and has a first end and a second end corresponding and attached to the first end and the second end of the third carrier 38.

In view of the foregoing, a bike frame can be lifted from the ground by the bike repair stand 10 and supported in different angular positions according to operating conditions, the first carrier 36 can support the junction of an upper tube and a seat tube of the bike frame, the second carrier 37 can support the upper tube of the bike frame, the third carrier 38 can support the seat tube of the bike frame, the second extension rod 34 is movable to allow a user to adjust the distance between the first carrier 36 and the second carrier 37 according to the size of the bike frame, the first extension rod 32 is rotatable to allow the user to change angular positions of the bike frame, and the bike frame is supported in three points and tightened to the bike repair stand 10 by the first, the second, and the third restrainers 361, 371 and 381, thereby providing a three-point fixing effect and restraining the bike frame stably.

Although specific embodiments have been illustrated and described, numerous modifications and variations are still possible without departing from the scope of the invention. The scope of the invention is limited by the accompanying claims.

1. A bike repair stand comprising:
a support rod assembly including an upright pole, a sliding seat, a plurality of supporting legs, and a plurality of linkages, wherein the sliding seat is movably connected to and movable along the upright pole in a transition between collapsed and extended positions of the bike repair stand, wherein each of the plurality of supporting legs has a first end pivotally connected to the sliding seat and a second end, wherein each of the plurality of linkages has a first end pivotally connected to the upright pole and a second end pivotally connected to one of the plurality of supporting legs, wherein the sliding seat is in a first position the plurality of supporting legs fold up when the bike repair stand is in the collapsed position, and wherein the sliding seat is in a second position the plurality of supporting legs spread apart when the bike repair stand is in the extended position; and
an extension rod assembly including a first connection structure, a first extension rod, a second connection structure, a second extension rod, and a third extension rod, wherein the first connection structure is mounted to the upright pole, wherein the first extension rod is arranged in a horizontal direction and has a first end rotatably connected to the first connection structure and a second end, wherein the second connection structure is mounted to the second end of the first extension rod, wherein the second extension rod is movably connected to the second connection structure and arranged orthogonal to the first extension rod, wherein the third extension rod has a first end mounted to the second connection structure and a second end, wherein the extension rod assembly further includes first, second, and third carriers on which a bike is contacted, wherein the first carrier is mounted to the second connection structure, wherein the second carrier is mounted to the second extension rod, and wherein the third carrier is mounted to the second end of the third extension rod.

2. The bike repair stand as claimed in claim 1, wherein the upright pole has a bottom end and a top end opposite the bottom end, wherein each of the of the plurality of linkages includes the first end thereof pivotally arranged at the bottom end of the upright pole and the second end thereof pivotally arranged between the first and the second ends of the connected supporting leg, and wherein the first connection structure is arranged at the top end.

3. The bike repair stand as claimed in claim 2, wherein the first extension rod is movable relative to the first connection structure on a horizontal plane.

4. The bike repair stand as claimed in claim 3, wherein the first connection structure includes two first clamping arms for clamping first extension rod and a first fastener connected to the first clamping arms, wherein the first extension rod is arranged between the first clamping arms, wherein the first fastener is movable between a tightening position in which the first extension rod is tightly clamped by the first clamping arms and prevented from movement and rotation and an untightening position in which the first extension rod is released from the first clamping arms and movable, wherein the second connection structure includes two second clamping arms for clamping the second extension rod and a second fastener engaged with the two second clamping arms, wherein the second extension rod is arranged between the two second clamping arms, and wherein the second fastener is movable between a tightening position in which the second extension rod is tightly clamped by the second clamping arms and prevented from movement and an untightening position in which the second extension rod is released from the second clamping arms and movable.

5. The bike repair stand as claimed in claim 4, wherein the third extension rod has a first end rotatably connected to the second connection structure and is positionable at various angular positions fixedly with respect to the second connection structure, and wherein the third carrier is mounted to the second end of third extension rod.

6. The bike repair stand as claimed in claim 5, wherein the first, the second, and the third carriers respectively include first, second, and third restrainers attached thereto and configured to fasten the bike to the corresponding carriers.

7. The bike repair stand as claimed in claim 6, wherein the first carrier has a first end adjacent to the second connection structure and a second end opposite the first end distant from the second connection structure, wherein the first restrainer is a belt and has a first end and a second end corresponding and attached to the first end and the second end of the first carrier, wherein the second carrier has a first end adjacent to the second extension rod and a second end opposite the first end distant from the second extension rod, wherein the second restrainer is a belt and has a first end and a second end corresponding and attached to the first and the first end and the second end of the second carrier, wherein the third carrier has a first end adjacent to the third extension rod and a second end opposite the first end distant from the third extension rod, and wherein the third restrainer is a belt and has a first end and a second end corresponding and attached to the first end and the second end of the third carrier.

8. The bike repair stand as claimed in claim 4, wherein the first fastener is inserted into the two first clamping arms and in thread engagement with one of the two first clamping arms, and wherein the second fastener is inserted into the two second clamping arms and in thread engagement with one of the two second clamping arms.

9. The bike repair stand as claimed in claim 7, wherein each of the first, the second, and the third carriers has a smaller cross section that that of each of the first and the second ends.

10. The bike repair stand as claimed in claim 1, wherein the first, the second, and the third carriers are arranged along a vertical direction of the bike repair stand at different heights and disposed adjacent to the upright pole when the bike repair stand is in the collapsed position.
